(19) United States
(12) Patent Application Publication
(10) Pub. No.: US 2015/0287006 A1
(43) Pub. Date: Oct. 8, 2015

(54) Tab Management Method And Apparatus

(71) Applicant: CLIPP PTY LTD, Sydney (AU)

(72) Inventors: Stuart Hunter, Balmain East (AU); Craig Stanford, Albion Park Rail (AU); Gregory Taylor, Sydney (AU)

(73) Assignee: CLIPP PTY LTD, Sydney (AU)

(21) Appl. No.: 14/247,825

(22) Filed: Apr. 8, 2014

(51) Int. Cl. G06Q 20/14; H04L 29/08; G06Q 20/32; G06Q 20/20

(52) U.S. Cl. CPC G06Q 20/145; G06Q 20/202; H04L 67/28; G06Q 20/3224

(57) ABSTRACT

Apparatus for managing a tab relating to purchases, the apparatus including a sales terminal, a client device and an account server in communication via one or more communications networks. The account server provides an open tab message to the sales terminal, which opens a tab for the user and provides a tab identifier message to the account server. The account server provides an indication of the tab identifier to the client device allowing a user of the client device to present the tab identifier when making a purchase so that the purchase can be added to the tab. The sales terminal provides a tab balance message to the account server, which processes payment of the tab on behalf of the user in accordance with the tab balance and provides payment confirmation to the sales terminal.

### BACKGROUND OF THE INVENTION

The present invention relates to a method and apparatus for managing a tab relating to purchases, for example of food or beverages, as well as to a method and apparatus for messaging in a system for managing a tab.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

It is known to provide accounts in venues in respect of the purchase of consumables such as food and drinks, commonly referred to as a “tab”. In existing situations, tabs are typically established by having a customer provide details of a payment mechanism, such as a credit card, to staff working in a venue. The staff issue the user with some form of identifier, such as a bar tab number, card, or the like. When making a purchase the user may simply present the number or card, with the cost of the purchase being added to the tab, which is then settled at the end of the evening using the payment mechanism provided.

This process suffers from a number of drawbacks. For example, it can be time consuming for staff to establish the tab, easy for other individuals to fraudulently purchase items on a user's tab and difficult for user's to track the balance on the tab. Finally, settlement of the tab can be problematic, for example as the user has to request to close the tab and then make the payment by retrieving their credit card and having the bar staff process the payment. This is not only time consuming, but also occurs when the customer is wishing to leave which is potentially inconvenient. Additionally, customer's often forget to settle up their bar tab which means this needs to be done at a later date, which is again inconvenient and difficult for the venue to manage.

### SUMMARY OF THE PRESENT INVENTION

In one broad form the invention provides apparatus for managing a tab relating to purchases, the apparatus including:
a) a sales terminal;
b) a client device; and,
c) an account server in communication with the sales terminal and the client device via one or more communications networks, wherein in use:
   i) the account server provides an open tab message to the sales terminal;
   ii) the sales terminal:
      (1) opens a tab for the user; and,
      (2) provides a tab identifier message to the account server, the tab identifier message being indicative of a tab identifier;
   iii) the account server provides an indication of the tab identifier to the client device allowing a user of the client device to present the tab identifier when making a purchase so that the purchase can be added to the tab;
   iv) the sales terminal provides a tab balance message to the account server, the tab balance message being indicative of at least a tab balance; and,
   v) the account server:
      (1) processes payment of the tab on behalf of the user in accordance with the tab balance; and,
      (2) provides payment confirmation to the sales terminal

Typically the apparatus includes a proxy server that communicates with the account server and a sales module in the sales terminal to transfer messages therebetween.

Typically the proxy server is implemented using computer executable code executed by the sales terminal.

Typically the proxy server selectively queues messages being transferred between the sales module and the account server.

Typically the proxy server:
a) determines if a message should be queued; and,
b) depending on the result of the determination, at least one of:
   i) queuing the message; and,
   ii) transferring the message.

Typically the proxy server determines a message should not be queued in accordance with at least one of:
a) a message type;
b) a message content; and,
c) if the message is a response message.

Typically the proxy server:
a) receives a message from the account server via a communications network;
b) queues the message; and,
c) provides the message to the sales module in response to a polling request.

Typically the proxy server confirms at least one of:
a) receipt of the message from the account server; and,
b) failure of message delivery to the sales module.

Typically the proxy server deletes uncollected queued messages.

Typically the proxy server:
a) receives a message from the sales module;
b) queues the message; and,
c) periodically provides queued messages to the account server via a communications network.

Typically the proxy server:
a) transfers an open tab message from the account server to the sales module; and,
b) transfers a tab identifier message from the sales module to the account server.

Typically the proxy server at least one of:
a) transfers a close tab message from the account server to the sales module;
b) transfers a tab balance message from the sales module to the account server; and,
c) transfers a payment confirmation message from the account server to the sales module.

Typically:
a) the client device provides an open tab indication to the account server including an indication of a venue; and,
b) the account server uses the open tab indication to generate the open tab message.

Typically the client device:
a) determines a location;
b) displays a list of venues in accordance with the determined location;
c) determines user selection of a venue in accordance with user input commands; and,
d) generates the open tab indication using the selection of a venue.

Typically the client device:
a) detects a venue network device or beacon; and,
b) generates the open tab indication at least partially in accordance with detection of the venue network device.

Typically:
a) the client device:
   i) determines user selection of a tab limit; and,
   ii) provides an indication of the tab limit to the account server; and,
b) the account server uses the tab limit indication to generate the open tab message.

Typically the account server:
a) performs a pre-authorisation transaction based on the tab limit; and,
b) generates the open tab message in response to a successful completion of the pre-authorisation transaction.

Typically the sales terminal:
a) compares a current tab balance to the tab limit; and,
b) in accordance with the results of the comparison, at least one of:
   i) selectively approves a purchase; and,
   ii) generates a notification an increased tab limit or payment is required, the notification being displayed on at least one of the sales terminal and the client device.

Typically, in response to a purchase:
a) the sales terminal:
   i) generates a tab balance message including an updated tab balance; and,
   ii) provides the tab balance message to the account server;
b) the account server provides an indication of the tab update to the client device; and,
c) the client device displays an indication of the updated tab balance.

Typically:
a) the client device:
   i) determines payment information using user input commands; and,
   ii) provides an indication of the payment information to the account server; and,
b) the account server processes payment of the tab using the payment information.

Typically:
a) the sales terminal closes the tab and provides a tab closed message to the account server, the tab closed message including a final tab balance; and,
b) the account server:
   i) processes payment of the tab in accordance with the final tab balance; and,
   ii) provides a payment confirmation message to the sales terminal

Typically:
a) the client device provides a close tab indication to the account server in response to user input commands;
b) the account server
   i) generates a close tab message; and,
   ii) provides the close tab message to the sales terminal; and,
c) the sales terminal closes the tab in response to the close tab message.

In one broad form the invention provides a method for managing a tab relating to purchases, the method including:
i) in an account server, providing an open tab message to a sales terminal;
ii) in the sales terminal:
   (1) opening a tab for the user; and,
   (2) providing a tab identifier message to the account server, the tab identifier message being indicative of the tab identifier;
iii) in the account server, providing the tab identifier to a client device allowing a user of the client device to present the tab identifier when making a purchase so that the purchase can be added to the tab;
iv) in the sales terminal, providing a tab balance message to the account server, the tab balance message being indicative of at least a tab balance; and,
v) in the account server:
   (1) processing payment of the tab on behalf of the user in accordance with the tab balance; and,
   (2) providing payment confirmation to the sales terminal

In one broad form the invention provides apparatus for messaging in a system for managing a tab, the apparatus including:
a) a sales terminal having a sales module;
b) an account server; and,
c) a proxy server in communication with the sales module and the account server, wherein in use, messages transferred between the account server and sales module are transferred via the proxy server with the proxy server selectively queuing messages as required.

Typically the proxy server:
a) determines if a message should be queued; and,
b) depending on the result of the determination, at least one of:
   i) queuing the message; and,
   ii) transferring the message.

Typically the proxy server determines a message should not be queued in accordance with at least one of:
a) a message type;
b) a message content; and,
c) if the message is a response message.

Typically the proxy server:
a) receives a message from the account server via a communications network;
b) confirms receipt of the message from the account server;
c) queues the message; and,
d) provides the message to the sales module in response to a polling request from the sales module.

Typically the proxy server:
a) confirms failure of message delivery to the sales module; and,
b) deletes uncollected queued messages.

Typically the proxy server is implemented using computer executable code executed by the sales terminal.

Typically the proxy server:
a) receives a message from the sales module;
b) queues the message; and,
c) periodically provides queued messages to the account server via a communications network.

Typically the proxy server, at least one of:
a) transfers a close tab message from the account server to the sales module;
b) transfers an open tab message from the account server to the sales module; and,
c) transfers a tab identifier message from the sales module to the account server.

Typically the proxy server:
a) transfers a tab balance message from the sales module to the account server; and,
b) transfers a payment confirmation message from the account server to the sales module.

In one broad form the invention provides a method for messaging in a system for managing a tab, the system including a proxy server in communication with a sales terminal having a sales module and an account server, the method including transferring messages between the server and sales module via the proxy server with the proxy server selectively queuing messages as required.

### BRIEF DESCRIPTION OF THE DRAWINGS

An example of the present invention will now be described with reference to the accompanying drawings, in which: —

FIG. 1 is a schematic diagram of an example of an apparatus for managing a tab;

FIG. 2 is a flowchart of an example of a method for managing a tab;

FIG. 3 is a flowchart of an example of a method of messaging used in managing a tab;

FIG. 4 is a schematic diagram of a second example of apparatus for managing a tab;

FIG. 5 is a schematic diagram of an example of a processing system;

FIG. 6 is a schematic diagram of an example of a sales terminal;

FIG. 7 is a flow chart of an example of a process for user registration;

FIGS. 8A to 8D are a flow chart of a further example of a method for managing a tab; and,

FIGS. 9A and 9B are a flowchart of an example of sharing a tab.

### DETAILED DESCRIPTION OF THE PREFERRED EMBODIMENTS

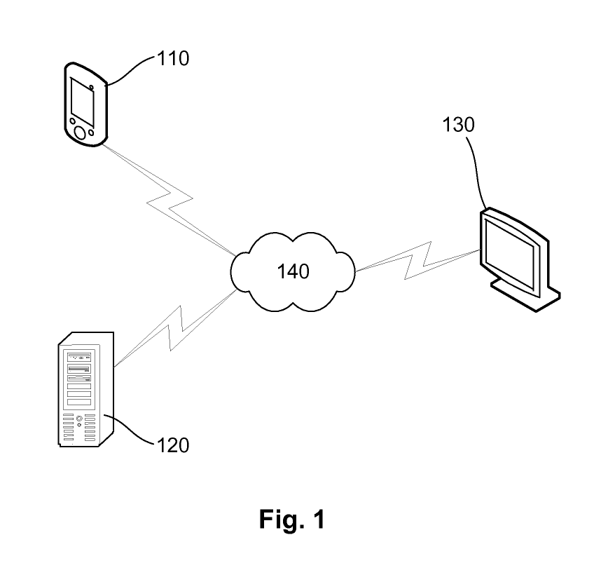

An example of apparatus for use in managing a tab will now be described with reference to FIG. 1.

For the purpose of the following, the term “tab” will be understood to encompass any type of account, invoice or bill issued in a scenario where one or more purchases are performed made during a time period and on credit, with the purchase(s) being paid for collectively.

In this example, the apparatus 100 includes a client device 110, an account server 120 and a sales terminal 130, interconnected via one or more communications networks 140.

The sales terminal 130 is typically in the form of a point of sales (POS) terminal provided at a venue and is utilised in receiving and processing payments from customers for the purchase of consumables such as food or drinks. The sales terminal is typically a standard sales terminal with minor modifications for utilisation in the current process. The sales terminal generally includes specific hardware, such as interfaces for cash draws, credit card readers, bar code scanners, or the like as well software systems such as a sales module for performing processing for processing payments and managing tabs.

The account server 120 is typically in the form of one or more processing systems, such as network or web servers, that are adapted to manage a user account and interface with the sales terminal to allow the tab to be managed. The client device 110 is typically in the form of a mobile phone, Smartphone, tablet, laptop, PC, or the like, which is capable of communicating with the account server 120 to allow the user to manage the tab. The client device 110 is typically associated with a user, but may optionally be associated with a venue to allow customers that are not existing users to register and interact with the system. The communication networks 140 can be any form of communications network, such as the Internet, one or more local area networks, or the like. Examples of specific arrangements will be described in more detail below.

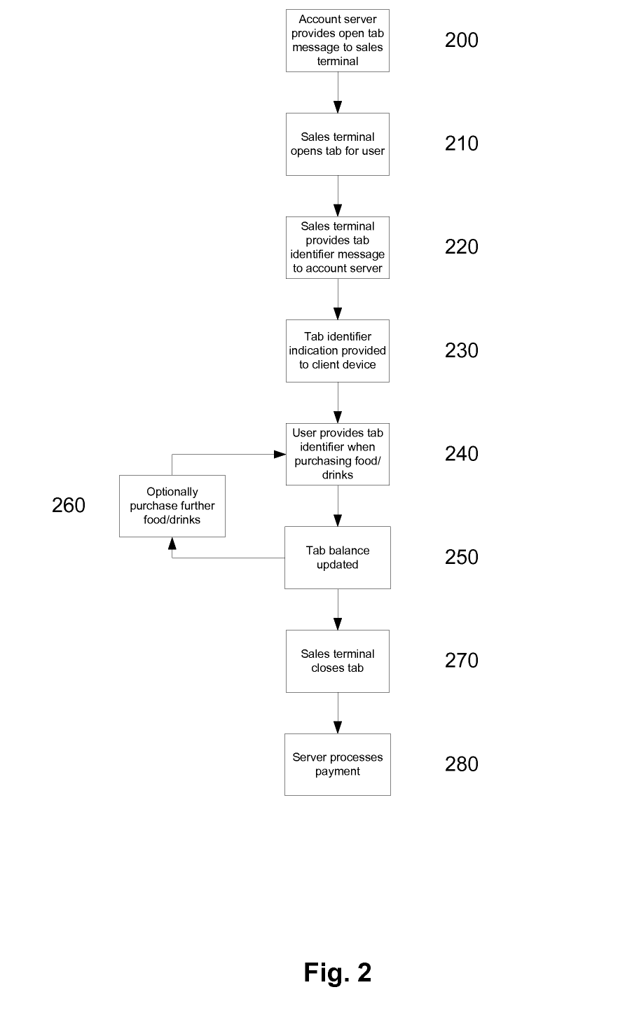

An example of a process for managing a tab will now be described with reference to FIG. 2.

In this example, the account server 120 provides an open tab message to the sales terminal 130 at step 200. The account server 120 can provide the open tab message in response to any one of a number of triggers, such as prompting by user input provided via the client device 110, as will be described in more detail below. The open tab message will typically include any required information, such as information for identifying the user, any tab limits associated with the tab, or the like. The nature of the open tab message and the manner in which the message is transferred will vary depending on the preferred implementation, as will be described in more detail below.

The open tab message is transferred to the sales terminal 130, causing the sales terminal to open a tab for the user at step 210. The sales terminal is therefore adapted to receive the open tab message and utilise this as a trigger to establish a tab, which is typically performed in accordance with standard sales terminal operating procedures. Accordingly, in this example, the open tab messages substitute for manual interaction with the sales terminal that would previously have been performed by staff in a venue or other locations.

At step 220, the sales terminal provides a tab identifier message indicative of a tab identifier to the account server 120. In this regard, the tab identifier is generated by the sales terminal 130 during the process of opening the tab and is used to subsequently identify the tab. The tab identifier could be in any one of number of forms, such as a unique alpha numeric code, or the like and could include coded data, such as a bar code, QR code, or the like.

At step 230, the account server transfers an indication of the tab identifier to the client device 110, allowing the user to provide the tab identifier to venue staff when purchasing food or drinks at step 240. It will be appreciated that the manner in which is this is achieved will vary depend on the implementation and the nature of the tab identifier. Thus, for example, if the tab identifier is an alpha numeric code, this could involve having the user provide an indication of the code verbally. Alternatively, the user could present the client device 110, such as a Smartphone, to the venue staff allowing the venue staff to determine the tab identifier visually. This may therefore involve having the venue staff manually enter the tab identifier into the sales terminal 130, or alternatively could involve utilising a scanning device associated with the sales terminal, such as bar code scanner, to scan a coded data identifier presented on a display of the client device 110.

At step 250, the tab balance is updated when the venue staff member enters details of the purchased food or beverage items into the sales terminal, with a tab balance message indicative of at least the updated tab balance being generated by the sales terminal 130 and transferred to the account server 120. The tab balance message may also include additional information such as a list of purchased items, numbers of items and cost, as will be described in more detail below. At this point, the process could proceed to step 260 allowing additional food or drinks to be purchased, with a check also being optionally performed to ensure the tab does not exceed a defined tab limit.

Otherwise the tab is closed by the sales terminal 130 at step 270, either in response to input commands from venue staff, or input provided by the user via the client device 110, allowing the account server 120 to process payment on behalf of the user, in accordance with the tab balance, at step 280. Thus, the user could indicate to venue staff that they wish to close the tab, in which case closing of the tab is controlled via the sales terminal, with this being communicated to the account server. More typically however, the user can indicate via the client device 110 that they wish to close the tab with this being communicated to the account server 120, and then to the sales terminal 130, so that closing of the tab is initiated remotely.

In any event, the account server processes payment for example by debiting a payment account, such as the user's PayPal or credit card account and then provides a payment confirmation message to the sales terminal at step 270, allowing the sales terminal to optionally close the tab at step 280. In one example, the account server can process the payment by transferring funds to an account of the venue directly from the user. More typically however, funds are received from the user into an account administered by an operator of the system, with payment being made to the venue at an appropriate time, such as on a daily or weekly basis, depending on the preferred implementation.

Accordingly, the above described process allows a user to manage a tab using a client device 110 that interacts with an account server 120. The account server 120 in turn communicates with a sales terminal 130 provided in a venue. This allows the tab to be operated using existing sales terminals 130 within a venue, so that venue staff can continue to interact with the sales terminals 130 substantially in accordance with existing techniques. Despite this, the process provides a mechanism for allowing the user to control opening, closing and payment of the tab using a client device 110, with these tasks being handled by the account server. This reduces the workload on venue staff, whilst making the management of the tab more straightforward and convenient for the user, including allowing the user to open or close the tab offsite using their own phone or other device.

In order for the above described process to function correctly it is useful to ensure that messaging between the account server and sales terminal can be performed reliably and in particular that failures in communication do not lead to the tab operating incorrectly. Additionally, it is desirable if the above described tab management process can be performed using existing sales terminals with minor or no modifications.

In order to address this, in one example a proxy server is utilised at the venue in order to handle communications between the sales terminal 130, and in particular the sales module of the sales terminal, and the account sever 120. In use, messaging between the sales module and the account server includes transferring messages between the account server and sales module via the proxy server, with the proxy server selectively queuing messages as required, so that these can be subsequently delivered to the sales module or account server as appropriate.

Thus, the proxy server effectively operates to separate the ability to communicate between the sales terminal and the account server from operation of the sales module, with communication between the venue and the account server being handled by the account server and proxy server independent of operation of the sales module. This removes the complexity in ensuring successful communication between the account server and venue from the sales module, minimising the modifications required in order to implement this process using existing sales terminals. Thus, the proxy server could be installed on the sales terminal as a separate stand alone software application, that communicates with the existing sales module, with only minor modifications to existing messaging protocols used by the sales module being required. This allows the sales terminal to be modified for use in the tab management process through a simple software update, which in many cases can be performed remotely, therefore requiring no action by the venue.

Additionally, this process allows the sales module to function even in the event that communication between the sales terminal and account server fails, as the sales module can continue to generate any required messages, with these being queued by the proxy server until communications are restored. This allows the sales module to default to offline processing in accordance with standard tab processing existing techniques, so that failure of the account server, or communication with the account server, does not prevent the sales terminal being used in accordance with standard techniques.

Accordingly, it will be appreciated that the above described process provides a mechanism communications between the account server and the sales terminal to be performed reliably and with minimal modification being required to the sales module within the sales terminal. This in turn helps ensure easy deployment of the above described tab management system into existing venues.

The proxy server can be implemented as a separate stand alone device provided at the venue, and coupled to the sales terminal via a communications network, or could alternatively be integrated into the sales terminal. For example, this could be achieved by modifying the existing terminal through an appropriate firmware or software update. In either case, the proxy server is typically adapted to provide the messages to the sales module in the sales terminal.

A number of further features will now be described.

In one example, the proxy server determines if a message should be queued and depending on the result of the determination, either queues the message or transfers the message to the account server or sales module as required. In order to assess whether a message should be queued, the proxy server can examine the message and selectively queue or not queue the message based on a suitable assessment criteria, such a message type, message content or whether the message is a response message. Thus, whilst the majority of messages can be queued, in some scenarios it is necessary to transfer messages immediately, for example if the message requires an immediate response. Accordingly, the proxy server can be adapted to assess the message and automatically bypass the queue if required.

In one example, the proxy server receives a message from the account server via a communications network, queues the message and provides the message to the sales module in response to a polling request. This allows the message to be held in the queue until the sales module is ready to receive the message. The proxy server also typically confirms receipt of the message from the account server, allowing the account server to resend messages in the event that these are not successfully received by the proxy server. It will be appreciated that the proxy server can be adapted to delete messages from the queue if they are not collected within a predetermined time period, and also provide an indication of this to the account server 120, so the account server 120 is informed if messages are not successfully delivered.

The proxy server also typically receives a message from the sales module, queues the message and periodically provides queued messages to the account server via a communications network, again ensuring successful transfer of messages to the account server. It will be appreciated that the proxy server can also be adapted to inform the sales module in the event that the messages are not successfully delivered.

As part of the tab management process, the proxy server typically transfers an open tab message from the account server 120 to the sales module and transfers a tab identifier message from the sales module to the account server 120. The proxy server may also operate to transfer a close tab message from the account server to the sales module, a tab balance message, including an indication of at least a tab balance and optionally an itemized list of the tab, from the sales module to the account server 120 and/or transfer a payment confirmation message from the account server 120 to the sales module.

During management of a tab, the client device 110 typically provides an open tab indication to the account server 120, the open tab indication including an indication of a venue, with the account server 120 using the open tab indication to generate the open tab message.

As part of this, the client device 110 can determine a location, display a list of venues in accordance with the determined location, determine user selection of a venue in accordance with user input commands and generate the open tab indication using the selection of a venue. Thus, this allows a location to be used to identify nearby venues, thereby allowing a user to open a tab based for example on their current location. Additionally and/or alternatively, the client device 110 can detect a venue network device, a proximity beacon or the like, and generate the open tab indication at least partially in accordance with detection of the venue network device, allowing the venue to be identified automatically through detection of an appropriate network device. It will be appreciated that this can be used to facilitate open of the tab, thereby encouraging use of the system.

When opening a tab, the client device 110 typically determines user selection of a tab limit and then provides an indication of the tab limit to the account server 120 so that the account server 120 can use the tab limit indication to generate the open tab message. This in turn allows the tab limit to be known by the sales terminal 130 so that the sales terminal 130 can compare a current tab balance to the tab limit then use results of the comparison to either approve a purchase or generate a notification an increased tab limit is required. The notification could be displayed either to the venue staff via the sales terminal 130, or to the user via the client device 110. This prevents users overspending on their tab, and helps venues be confident that tabs will be successfully paid.

As part of the process of opening a tab, the user will be directed to select a payment option. The payment option could include for example using a credit card, debit card, Paypal account or other suitable payment mechanism. To allow the payment to be made, the user will also typically have to provide payment information, such as credit card details, or the like. This payment information can be provided as part of a registration process system, or when opening a tab. In either case, the client device 110 can determine payment information using user input commands and then provide an indication of the payment information to the account server 120, allowing the account server 120 to process payment of the tab using the payment information.

Additionally, as part of the tab opening process, the account server typically performs a pre-authorisation transaction based on the tab limit and generates the open tab message in response to a successful completion of the pre-authorisation transaction. Thus, a pre-authorisation transaction is typically performed to secure funds up to the tab limit, thereby ensuring that the tab can be paid. It will be appreciated that the tab can be cancelled if the user pays through other means, or partially refunded if the entire tab limit is not spent.

In general, when a purchase occurs, the sales terminal 130 generates a tab balance message including at least an updated tab balance and provides the tab balance message to the account server 120. The account server 120 then provides an indication of the tab balance to the client device 110, allowing the client device 110 to display an indication of the updated tab balance, thereby allowing the user to keep track of tab expenditure.

In general final payment occurs when the tab is closed and the final tab balance is known. In this regard, the tab is typically closed by the sales terminal by having the sales terminal close the tab and provide a tab closed message to the account server, the tab closed message including a final tab balance. The account server 120 can then processes payment of the tab in accordance with the final tab balance and provides a payment confirmation message to the sales terminal.

Closing of the tab can be achieved by venue staff, or alternatively can be performed based on user input via the client device. In this case, the client device 110 provides a close tab indication to the account server 120 in response to user input commands. The account server generates a close tab message and provides this to the sales terminal 130, causing the sales terminal to close the tab and provide a tab closed message to the account server with the final tab balance. Accordingly, this provide a mechanism to allow users to close and settle the tab directly from the client device 110.

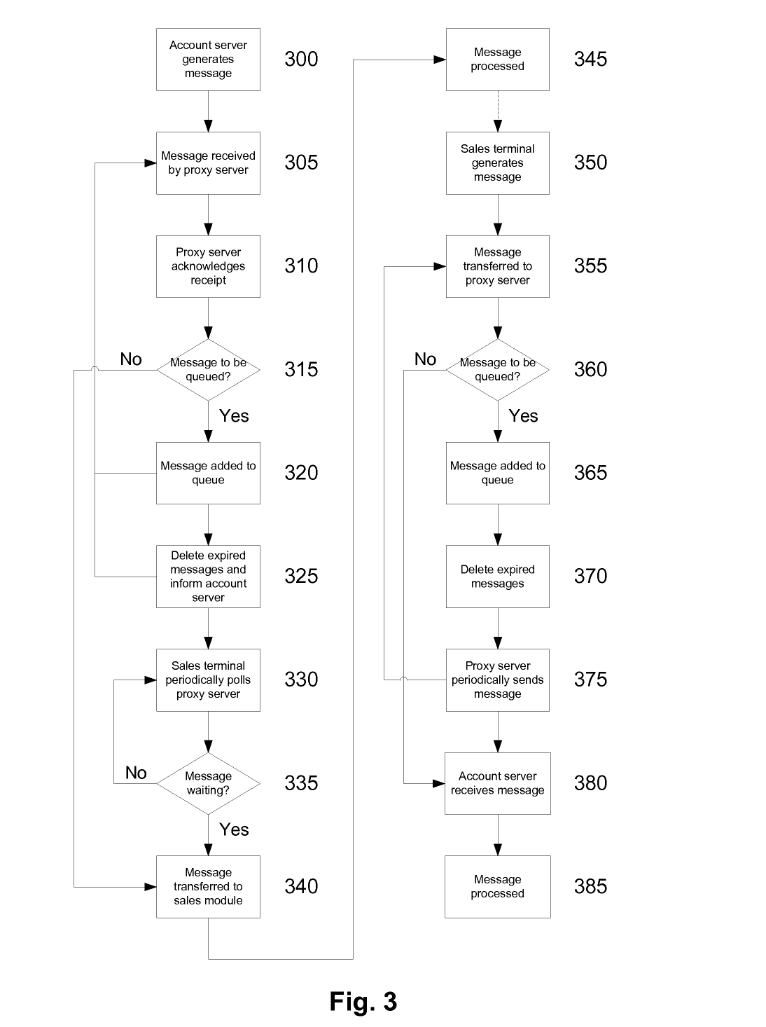

An example of a method of a method of messaging used in managing a tab will now be described in more detail with reference to FIG. 3.

In this example, when the account server 120 is transferring a message to the sales terminal 130, the account server 120 generates the message at step 300, transferring the message to the proxy server at step 305, using an appropriate communications protocol. The proxy server then confirms receipt of the message and adds the message to a queue at step 310.

In this regard, the account server 120 and proxy server can be adapted to communicate using any one of a number of multiple communication protocols that might be available, with the proxy server selectively using one of these depending on the circumstances. For example, secure websockets could be selected as a preference, with SSE (Server Sent Events) or other techniques being provided as fallback positions, so that in the event that the account server does not receive confirmation of receipt of a message sent using a approach, this allows the account server 120 to resend the message, until receipt is confirmed, thereby ensuring the message is received at the venue. In practice, it is the proxy server that establishes the connection and selects the communication protocol. The proxy server is then responsible for maintaining an open connection at all times, thereby circumventing venue network/firewall issues that block incoming connections.

At step 315, the proxy server assesses whether the message is to be queued. In this regard, queuing may be undesirable in the event that a response to the message is required substantially immediately. This might occur for example in the process of making payment requests. Thus, for example when closing a tab, the sales terminal might need a substantially instantaneous confirmation the payment has been made. Accordingly, the proxy server reviews messages and determines whether or not they should be queued. The assessment can be performed in any appropriate manner, such as on the basis of a message type, message content, priority or whether the message is a response message. Assuming the message is to be queued, it is added to the queue at step 320, otherwise it is transferred directly to the sales module.

At step 325, the proxy server will also perform a check of the queue to delete any messages that have expired. In this regard, messages should only be queued for a given amount of time, after which they expire. Accordingly, this process allows the proxy server to delete expired messages and inform the account server 120, so that the account server is aware that a message has not been delivered. This allows the account server 120 to either attempt to resend the message and/or notify an operator that there is a communication problem, for example by generating an error message or the like.

Once this has been done, the proxy server will continue waiting for further messages by returning to step 305.

Simultaneously with this, the sales module is adapted to periodically poll the proxy server at step 330. If it is determined that there are no messages in the queue at step 335, then the process returns to step 330, until the next polling even occurs. In the event the messages are currently in the queue, then at step 335 the proxy server transfers the message(s) to the sales module, allowing these to be received at step 340 and subsequently processed at step 345, as required.

The process of transferring a message from the sales terminal 130 to the account server 120 will now be described. In this example, at step 350 the sales module in the sales terminal 130 generates a message and transfers this to the proxy server at step 355. The proxy server determines if the message is to be queued at step 360, and if not transfers the message directly to the account server 120. Otherwise, the proxy server queues the message at step 365 and optionally deletes any expired messages at step 370. Following this at step 375, the proxy server periodically sends the queued messages to the account sever, allowing the account server to receive the message at step 380 and then process this as required at step 385. Again, as part of this, confirmation of receipt of a message by the account server 120 can be used to ensure that the messages are successfully transferred.

Accordingly, in the above example, the proxy server handles communications between the sales module and account server 120, as previously described. In this regard, the sales module need only periodically generate a polling signal with messages then being transferred to the sales module from the proxy server for processing as required. Messages are queued in the proxy server so that messages are not lost due to any problems in operation of or communication with the sales module. Furthermore, by having the proxy server confirm receipt of messages from the account server, this further allows the account server 120 to repeatedly send messages until a receipt is acknowledged, thereby ensuring that messages are successfully communicated from the account server 120 and to the sales module within the sale terminal 130.

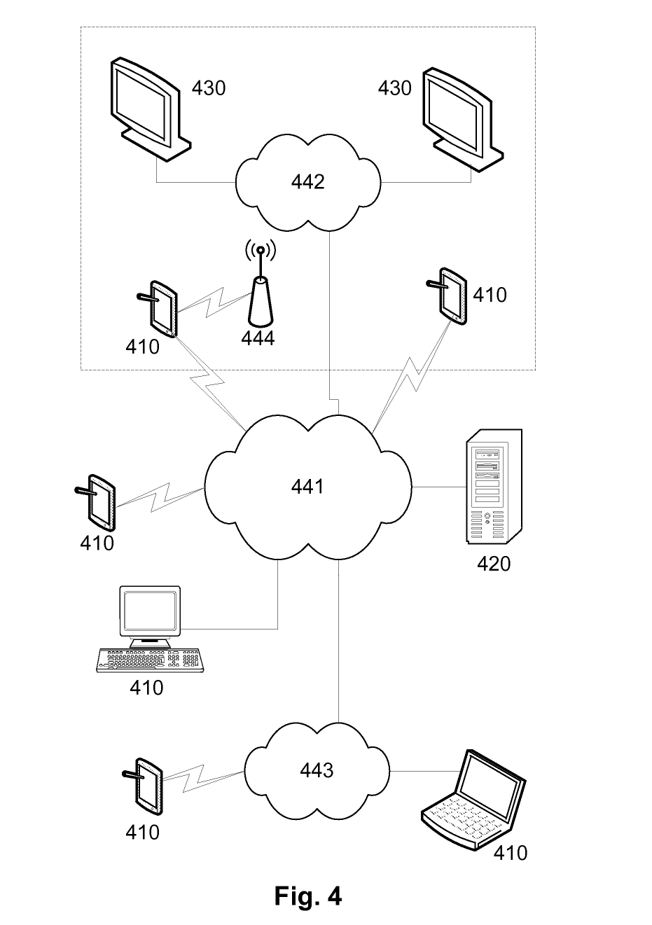

A specific example of apparatus for maintain a tab will now be described with reference to FIG. 4.

In this example, the apparatus includes a number of client devices 410, an account server 420 and a number of sales terminals 430, interconnected via communications networks 441, 442, 443. In this example, the communications network 441 is intended to represent one or more wide or global area networks, such as the internet, whereas the communications networks 442, 443 represent local area networks, for example in venues or other locations. For the purpose of this example, the communications network 442 is provided in a venue, shown by the dotted line, with the sales terminals 430 being connected via the communications network 442 to the internet 441. The account server 420 is connected to the internet 441 and the client devices 410 are coupled either to the communications network 443 or the internet 441. Additionally, the venue includes a network device 444, such as a proximity beacon, which can be in the form of a low energy Bluetooth technology beacon or the like, as will be described in more detail below.

However, as will be apparent from the following description, this arrangement is for the purpose of example only and is not intended to be limiting. In particular, it will be appreciated that the configuration of the networks are for the purpose of example only, and in practice the client devices 410, account server 420 and sales terminals 430 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

The account server 420 is typically in the form of a processing system coupled to a database. The account server is adapted to be used in managing the tab, as well as processing payments, managing user accounts, communicating with the client devices 410, and sales terminals 430, or the like. Whilst the account server 420 is a shown as a single entity, it will be appreciated that the account server can be distributed over a number of geographically separate locations, for example by using processing systems and/or databases that are provided as part of a cloud based environment.

The client devices 410 are typically in the form of a processing system adapted to communicate with the account server 420, allowing for user interaction with the account server.

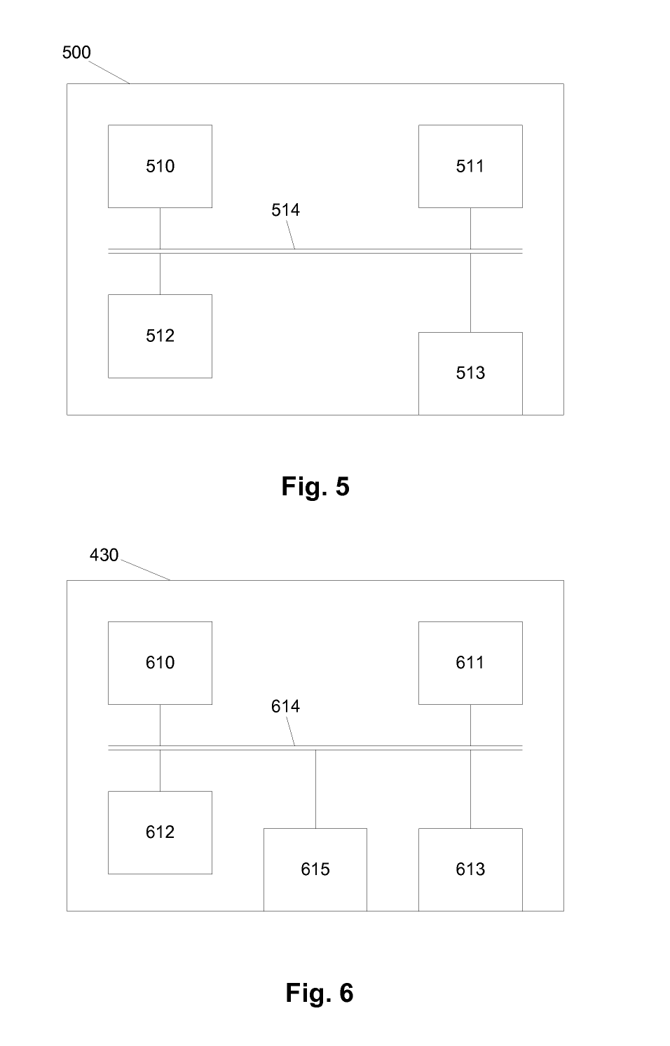

An example of a suitable processing system 500 is shown in FIG. 5. In this example, the processing system 500 includes at least one microprocessor 510, a memory 511, an optional input/output device 512, such as a keyboard and/or display, and an external interface 513, interconnected via a bus 514 as shown. In this example the external interface 513 can be utilised for connecting the processing system 500 to peripheral devices, such as the communications networks 441, 442, 443, network devices 444, databases, other storage devices, or the like. Although a single external interface 513 is shown, this is for the purpose of example only, and in practice multiple interfaces using various methods (eg. Ethernet, serial, USB, wireless or the like) may be provided.

In use, the microprocessor 510 executes instructions in the form of applications software stored in the memory 511 to relevant processes to be performed. Thus, in the case of the account servers, this could include generating and receiving messages, as well as interacting with the client device. In the case of the client device, this can include presenting a user interface for allowing user interaction, as well as communicating with the account server.

Accordingly, it will be appreciated that the processing systems 500 may be formed from any suitable processing system. In the case of the account server 420, this is typically in the form of a suitably programmed computer system, PC, web server, network server, or the like. For the client device 410, this typically includes a suitably programmed PC, Internet terminal, lap-top, hand-held PC, smart phone, PDA, web server, or the like. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

An example of a suitable sales terminal 430 will now be described with reference to FIG. 6. In this example, the sales terminal 430 includes at least one microprocessor 610, a memory 611, an input/output device including a touchscreen or keyboard and display, and an external interface 613, interconnected via a bus 614 as shown. The sales terminal also typically includes a payment device 615, such as an integrated card reader. In this example the external interface 613 can be utilised for connecting the sales terminals to peripheral devices, such as a barcode reader, or the like. In general, the sales terminal would be a custom device based on an Intel or similar architecture processing system, as will be appreciated by persons skilled in the art.

Examples of the tab management process will now be described in further detail. For the purpose of these examples, it is assumed that the client device is a smart phone, tablet or the like, implementing a software application in the form of an App that interacts with the account server 420. The account server also interacts with the sales module of the sales terminal, via a proxy server.

To achieve this the processor of the client device 410 typically executes software code implementing the App and allowing communications with the account server, with actions being performed by the processor 510 in accordance with instructions stored as applications software in the memory 511 and/or input commands received from a user via the I/O device 512. However, whilst reference is made to the use of an App for the following examples, it will be appreciated that similar functionality can be achieved via a standard web based interface such as a webpage or the like displayed by a browser application implemented by the client device.

Similarly the processor of the account server 420 typically executes applications software for interacting with the App of the client device 410, hosting the user account and communicating with the sales terminal 430. Accordingly, actions performed by account server are typically performed by the processor 510 in accordance with instructions stored as applications software in the memory 511 and/or input commands received from a user via the I/O device 512, or commands received from the client device 410.

Finally, the sales terminal implements a sales module for allowing operators, such as venue staff, to interact with the sales terminal through a user interface presented by the I/O device 612, and a proxy server to allow communications with the account server. Actions performed by the proxy server or sales module are performed by the processor 610 in accordance with instructions stored as applications software in the memory 611 and/or input commands received from the operator via the I/O device 612. In the current example, the processor 610 will implement both a sales module to manage the tab, receive details of purchases, and displaying information to an operator, as well as a proxy server for managing communication between the sales module and the account server 420 as previously described.

However, it will be appreciated that the above described configuration assumed for the purpose of the following examples is not essential, and numerous other configurations may be used. It will also be appreciated that the partitioning of functionality between the different processing systems may vary, depending on the particular implementation.

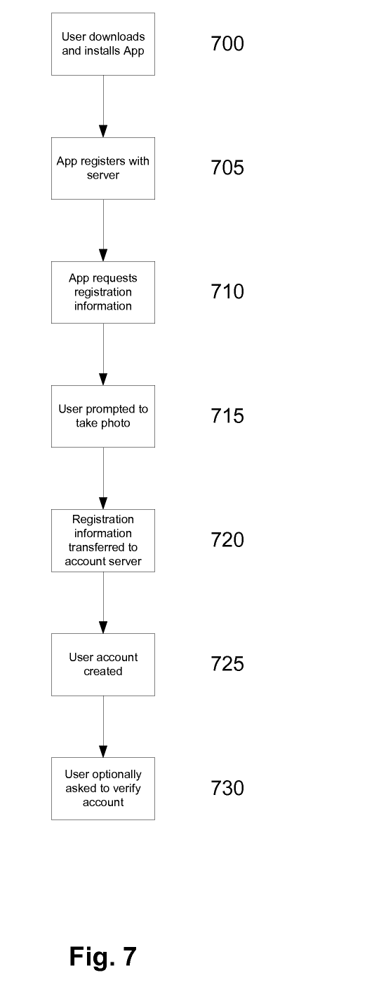

An example of a process for establishing a user account will now be described with reference to FIG. 7.

In particular, the user account is maintained by the account server 420 and is used to record details allowing the user to be identified as well as to store details of a user's payment details, user preferences, or the like.

In this example at step 700 the user downloads and installs the App on the client device 410 from an App store. The App initially registers with the account server 420 at step 705, confirming that the App has been installed and undergoing approval permissions or the like, in accordance with standard App installation protocols, and this will not therefore be further described.

At step 710 the App requests registration information from the user. This may be performed automatically on installation or in response to a user request to establish a user account. The registration information will typically include information required to contact the user such as a name, contact details, or the like, as well as authentication information, such as a password, PIN, or similar. In the event that the App is to be utilised for the purchase of alcoholic beverages it may also be typical to request the user provide date of birth information. Whilst this is not intended to be a legal check for the user's age it is nonetheless a requirement for the industry. At step 715 the user is also prompted to provide a photograph, for example using a camera of the client device 410, which is utilised as part of their registration information as will be described in more detail below.

At step 720, the registration information is transferred to the account server 420 with this being used to create a user account, which is typically stored in an account database. The user account will include the registration information and may further include additional information such as payment details or the like. In this regard, as part of this process, the user may be required to provide payment information such as details of a PayPal or credit card account, allowing this to be recorded as part of the user account as will be appreciated by a person skilled in the art.

Finally, at step 725, the user may be asked to optionally verify their account, for example by providing an email to a designated email address with the user verifying the account by selecting a URL embedded in the email or the like, redirecting a browser application of the client device to a webpage, allowing this to be with selection detected by the account server 420, as would be understood by persons skilled in the art.

As an alternative to the above described process, the user can alternatively register by connecting to an existing social media account (e.g. Facebook). In this case all details except the PIN will be taken from the social media account profile. It will therefore be appreciated that the above described registration process is for the purpose of example and is not intended to be limiting.

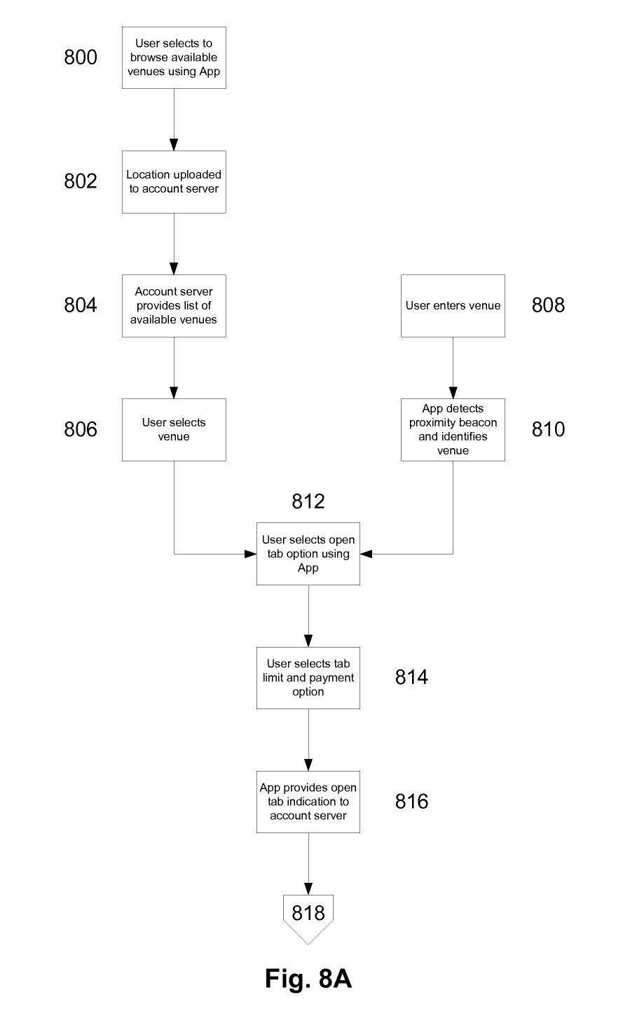

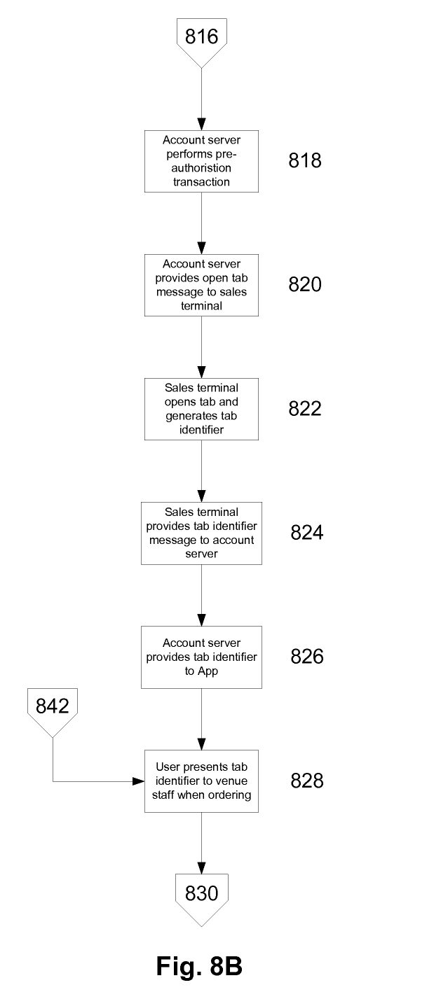

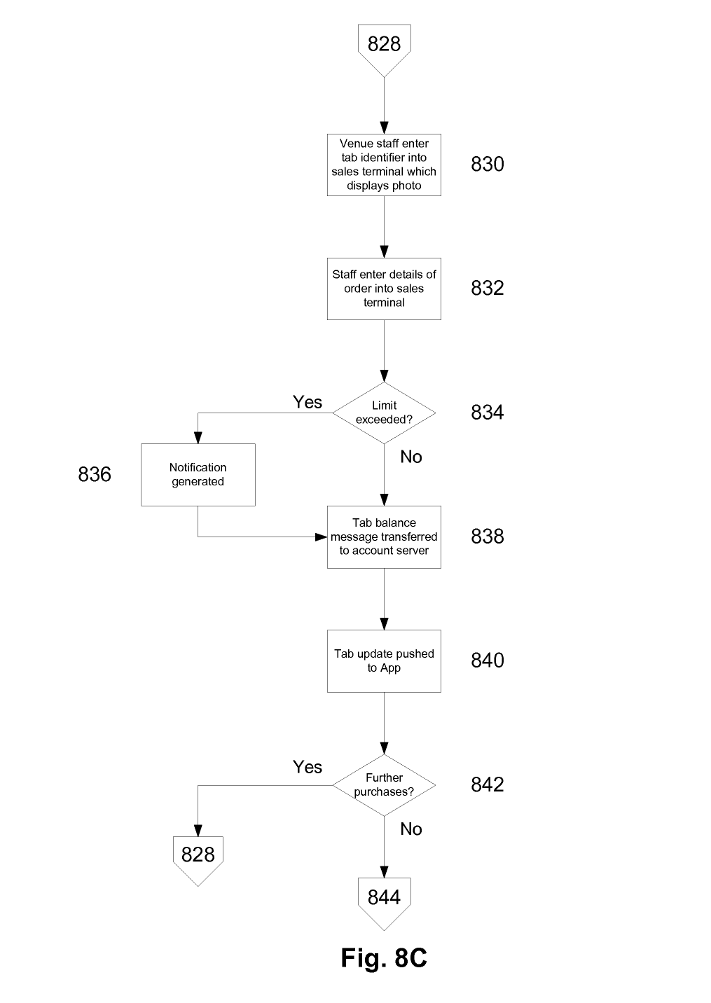

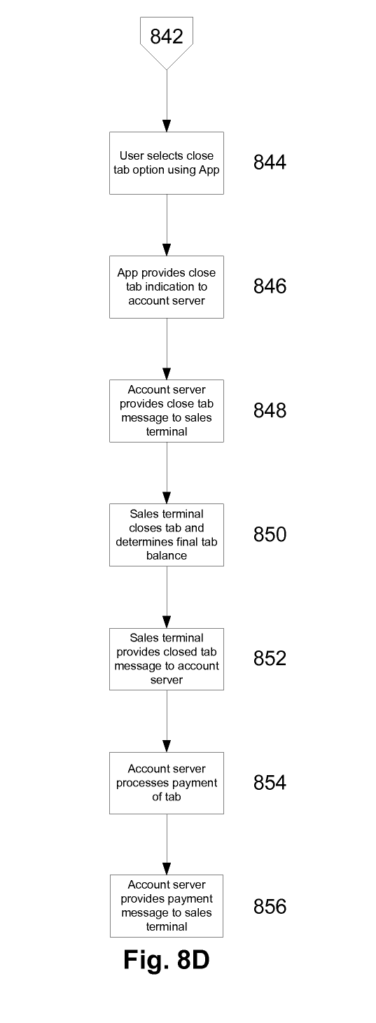

An example of the process for opening and using a tab will now be described with reference to FIGS. 8A to 8D.

Although not described in this example, it will be appreciated that the transfer of messages between the account server 420 and the sales terminal 430 occurs in accordance with the process outlined above in respect to FIG. 3.

In this example, the first stage is for the user to select a venue for which the tab is to be opened. This can be achieved via any suitable mechanism and two examples will now be described.

In the first example, the user opens the App and selects a browse available venues option displayed by the App at step 800, causing the App to upload a location indication to the account server 420, at step 802. The location indication can be determined using any appropriate technique, which could include having the user define a location, for example by entering a postcode, suburb name or the like. Alternatively the location could be automatically determined by the App, for example based on location information made available by the client device 410, such as GPS (Global Positioning System) information or the like. At step 804 the account server 420 responds to the location indication by providing a list of available venues in the vicinity of the location, with these being displayed to the user at step 806, allowing to select a venue of interest. Thus it will be appreciated that this is a user driven process that allows the user to view venues in their current vicinity and then select one of these to establish a tab for that venue.

In a second example, the user enters a venue at step 808, and the App detects the presence of a network enabled device or proximity beacon 444, using this to identify the venue at step 810. In this regard, the beacon 444 can broadcast a signal, such as a Bluetooth, Wi-Fi signal or the like, with this being detected by the App and used to identify the venue. This could be achieved in any appropriate manner, such as by having the beacon broadcast a unique code, with the App then communicating with the account server 420 to resolve the venue associated with the code. Alternatively, this could be based on a Wi-Fi network identifier or the like of a network enabled device or the network itself.

In either case, having determined the venue, the App displays an open tab option, allowing the user to select this at step 812. Having selected to open a tab, the App displays a user interface, allowing the user to enter required information, including a tab limit and payment option at step 814, with this being used to allow the App to provide an open tab indication to the account server 420 at step 816, the open tab indication including the tab limit and payment information.

As part of the above process, the App could display a number of pre-set amounts such as $20, $50, $100, or the like, allowing the user to select a predefined limit for tab expenditure. The payment options could be displayed in the form of a list, such a PayPal, credit card, etc. In one example, the payment details associated with a respective option, such as credit card numbers or the like, can be stored in the user account, in which case the App confirms this with the account server. Otherwise, the user can be prompted to enter required payment option details. It will be appreciated that this corresponds to a typical payment mechanism and will not be described in further detail.

Additionally, as part of the above process, the account server 420 may also perform a pre-authorisation transaction using the user's nominated payment details, thereby ensuring that the limit amount is covered upfront so that the venue can be assured of payment.

At step 818 the account server 420 performs a pre-authorisation transaction to secure funds up to the tab limit. If this is not successful, the user can be alerted and asked either to select a lower tab limit, or another payment mechanism.

Assuming the pre-authorisation transaction is successful however, the account server 420 provides an open tab message to the sales terminal at step 820. The open tab message to the sales terminal will include any required information to open and run the tab. Typically this will include information identifying the user and more typically will include a photo of the user, allowing venue staff to identify the user when purchasing food or drinks.

At step 822 the sales terminal 430 opens a tab and generates a tab identifier. This would be in accordance with standard bar tab opening procedures, the only variation being that this occurs in response to an open tab message, as opposed to manual operation by an operator.

At step 824 the sales terminal 430 provides a tab identifier message to the account server 420, allowing the account server 420 to store an indication of the tab identifier, and also provide a tab identifier indication to the app at step 826. The App can then display the tab identifier allowing the user to present this to venue staff when ordering a drink at step 828. In this regard, the venue staff can enter the tab identifier into the sales terminal either manually or by scanning a code displayed by the App, causing the sales terminal to display the photo of the user at step 830. It will be appreciated that this allows the bar operators to identify that the individual supplying the tab identifier is the legitimate tab owner, thereby reducing the opportunity for fraudulent use of the tab.

At step 832, the venue operator enters details of an order into the sales terminal 430 in the normal way. The sales terminal 430 compares the new tab total to a limit to determine if this is exceeded at step 834, and if so a notification is generated at step 836, either on the sales terminal 430 and/or the client device 410. The notification alerts the venue staff that the limit of the tab has been reached and that appropriate action should be taken. This can include closing the tab and refusing further purchases, allowing the tab limit to be increased or enabling the user to make a payment. For example, the user could be notified verbally by the venue staff allowing the user to use their client device to select an increased tab limit. This would trigger the account server to perform a further pre-authorisation transaction and notify the sales terminal of the new tab limit, for example using a process similar to that outlined above with respect to step 818 onwards. Alternatively, the user may be requested to make a payment or service could be refused.

Assuming the tab limit is acceptable, at step 838 the sales terminal 430 generates a tab balance message indicative of a new tab balance and details of purchases made, transferring this to the account server 420. The updated tab balance and purchases are stored at the account server 420 and additionally an indication of this is pushed to the App, so that the App can display a current tab balance and full details of tab expenditure, including details of all items purchased on the tab at step 840. This allows the user to review up to date details of the tab each time a purchase is made.

At step 842 it is determined that further purchases are required and if so the process returns to step 828. Otherwise the user selects a close tab option using the App at step 844, with the App providing a close tab indication to the account server 420 at step 846. The account server 420 provides a close tab message to the sales terminal 430 at step 848, allowing the sales terminal to close the tab and determine a final tab balance at step 850. It will be appreciated that this can be performed in accordance with standard sales terminal techniques, and a further option would therefore be to have venue staff initiate closing of the tab using the sales terminal.

At step 852, the sales terminal generates a closed tab message, which is transferred to the account server 820, allowing the account server to process payment of the tab at step 854, for example by debiting the user's credit card PayPal account or the like. At step 856 the account server 420 provides a payment message to the sales terminal 430, confirming payment has been made.

It will be appreciated from this that the users can remotely close the tab so that this provides the user with the ability to simply leave the venue as desired, then closing the tab at their own convenience. This avoids the user needing to approach venue staff and confirm that the tab has been closed, as well as avoiding the need for venue staff to take action to process payments and close the tab. This therefore makes the process more convenient for staff and users alike.

Additionally, tabs can be adapted to close in response to other events. For example, the tab could be adapted to time-out so that if purchases are not made for a predetermined amount of time, if the venue closes, or if the client device 410 leaves the vicinity of the venue, the tab can automatically be closed and payment processed, thereby providing comfort to the bar that payment will be provided in the event that the user forgets to close the tab.

The above described process has focused on the basic example of a user purchasing using their own tab. However, a number of additional features can be provided, including allowing users to provide access to their tabs to one or more third parties, splitting tabs, making payments towards tabs of other users, or the like, and the above example is not intended to be restrictive, but rather an exemplification of basic operation.

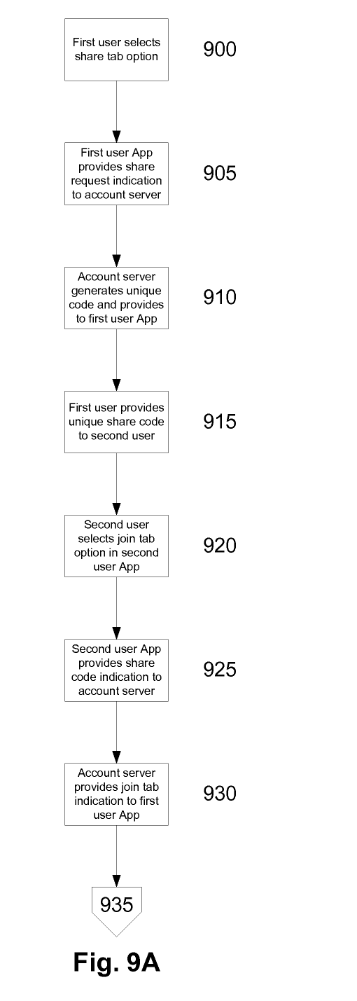

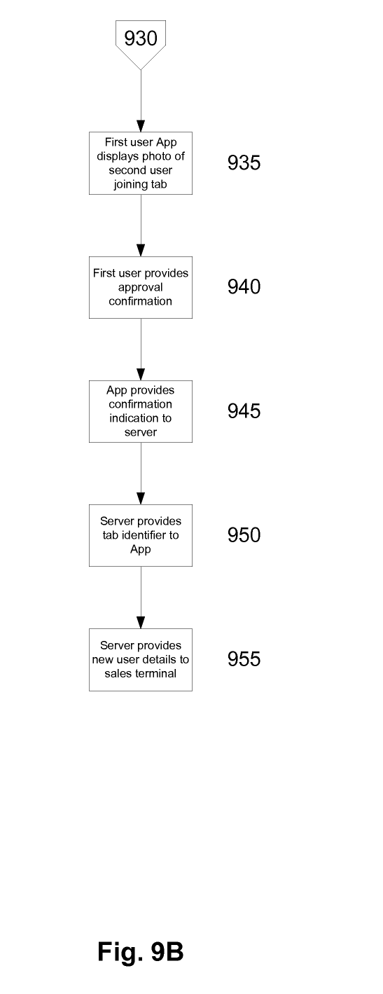

An example of a process for allowing a first user to share a tab with a second user will now be described with reference to FIG. 9.

In this example, at step 900 the first user selects a share tab option displayed by their App (first user App). The first user App provides a share tab request indication to the account server 420 at step 905, causing the account server 420 to generate a unique share code, which is then provided to the first user App at step 910. The share code can be of any appropriate form depending on the preferred implementation and could include an alphanumeric code, or coded data, such as a barcode, QR code, or the like.

The first user can then provide the share code to a second user at step 915, allowing the second user to select a join tab option using their own App (second user App) at step 920. The share code can be transferred via any appropriate mechanism, and this can be performed verbally, or alternatively in accordance with file transfer protocols, such as Bluetooth, infrared, imaging a coded data representation displayed by the first user App, or the like. As a further alternative the share code could be transferred via a message service, such as SMS, email or the like, or alternatively could be shared via social media, allowing the second user to retrieve the share code.

At step 925, the second App provides an indication of the share code to the account server 420, allowing the account server 420 to provide a join tab indication to the first user App at step 930. The first user App displays details of the second user, and in particular a photo of the second user at step 935, allowing the first user to provide confirmation that the individual should join the tab at step 940. The first user App will then provide a confirmation indication to the account server at step 945, with the account server 420 providing an indication of the tab identifier to the second user App at step 950. The account server 420 also provides details of the second user, including a photo, to the sales terminal at step 955, thereby allowing venue staff to approve the second user. It will be appreciated that in this instance, once the second user has joined the tab, they are then able to make purchases using the process described above with respect to steps 826 to 840.

In the above described process, each user of a particular tab can be given a common tab identifier. In this instance, when the venue staff enter details of the tab identifier, this can result in photos of each user being displayed. Alternatively however, each user can be assigned a unique tab identifier, with multiple tab identifiers being associated with a single tab.

In the above described process, it will be appreciated that the first user has to provide approval for any second user to join the tab. This means that the share code can be disseminated widely, without risk of third parties being able to use this to fraudulently join a tab. This makes it easier for a first user to run a tab on behalf of second users, and in particular makes it more straightforward to add second users to the tab.

As an alternative, the process can be configured to allow the first user to select second users in advance of creation of the share code. In this example, the first user App can be adapted to display information regarding other users of the system, allowing the first user to select one or more second users. In this instance, the account server 420 can be arranged to forward the share code to the second user Apps directly.

In a further alternative example, the share code could be the same as the tab identifier, in which case, the first user can simply broadcast the tab identifier to other users to allow them to join the tab, with the approval process being used to control whether users should be added. In this instance, steps 900 to 915 in the above described method would not be required. This could be achieved in any one of a number of ways, but in one example, the first user can select a ‘visible’ mode option for their tab in the first user App. This will then broadcast details of the tab to nearby users, for example based on the location of other Apps, or by using a short range communication process such as Bluetooth, thereby allowing nearby users to view details of and request to join the tab. At this point, the first user will receive a message with details of other users requesting to join the tab, thereby allowing them to accept or deny such requests.

In the above described examples, the first user is responsible for settlement of the tab. However, this is not essential and the process can also be adapted to allow multiple users to contribute to payment of an account. For example, once a second user has joined a tab, the second user can use the second user App to select a payment option, and then pay an amount towards the tab. The amount could be determined by the first or second user, or alternatively could be a fixed proportion of the tab balance.

In a further variation, a similar process to that described above can be used to generate a share payment code. In this example, the first user requests the share payment code be generated, and then sends this to one or more second users. The share payment code could be associated with a set payment value, such as $10, or a fixed split of the tab such as 50%, allowing other users to easily contribute towards the tab. Alternatively however, the share payment code may not have an associated value, in which case the second users could select an amount to pay, and then make payment in accordance with previously described payment processes. Thus, the second users would enter the share payment code into their App, select a payment amount and payment details, allowing the account server to process the payment as required. In this regard payment may be processed once the tab is closed, or alternatively could be applied to the tab immediately, thereby reducing the current tab balance. A payment by a second user could also be used to increase the tab limit, depending on the preferred implementation.

In the above example, the share payment code could be shared widely, for example allowing any user or other individual to contribute to a user's tab. For example, if it is the user's birthday, they could establish a tab at a bar, and then distribute a share payment code, asking friends or relatives to donate to their celebrations. In this instance, those wishing to contribute use their own App to make a payment towards the tab in a manner similar to that described above.

It will also be appreciated from this, that the above described arrangements could have a wide range of applications, and could for example be used as a mechanism for sharing a bill in a restaurant. In this example, when the sales terminal 430 generates the bill, the sales terminal 430 creates a tab identifier and provides an indication of the tab identifier on a bill, invoice, or the like. The sales terminal 430 also provides a tab identifier message to the account server 420, as well as a tab balance message with an indication of the bill amount. User's can then enter the tab identifier into their Apps, for example by scanning a code on the bill, manually entering an alphanumeric code, or the like. The App then forwards this to the account server 420, allowing the account server to identify the relevant tab and optionally cause a tab balance to be displayed by the App. The users can then select to make a payment, for example by selecting a payment mechanism, providing any required details, and optionally indicating how much they wish to pay. Alternatively, the account server 420 could split the bill evenly between the users, and also allow for the addition of a tip or gratuity.

In any event, it will be appreciated that in this instance, the process involves having the sales terminal initiate the creation of a tab to effect payment of a one off purchase, with the purchase being optionally split between users, and with the tab identifier being used to match payment to the respective bill. Alternatively however, a user can request a tab be opened, with payment being processed substantially as described above and assigned to the tab, which is then closed.

It will therefore be appreciated that the term “tab” could encompass any type of account, invoice or bill issued in a scenario where one or more purchases in a time period are to be paid for collectively.

Accordingly, the above described arrangement provides a Point of Sale (PoS) integrated technology that enables customers to securely open tabs and make payments in pubs, restaurants and hotels.

The arrangement processes customer payments on behalf of the venue and guarantees that payment will be made for all tabs and purchases. This removes the venue's risk of fraud from stolen cards or loss if a customer does not have sufficient credit available. Venues no longer need to physically retain a customer's credit card while a tab is open which ensures compliance with forthcoming PCI compliance rules.

The arrangement also provides operational efficiencies to the venue such as removing manual processes for opening and closing tabs, and provide a means of connecting venues with their customers for future marketing initiatives.

In one example, the arrangement provides for deep integration with the Point of Sale (PoS) system in each venue. Instead of operating a separate infrastructure with dedicated device to show account activity, the system is integrated so that it provides a simple payment type similar to Visa or Mastercard.

In the case of tabs, this integration means that there is no operational difference between a tab implemented as described above and a normal tab, except that the tab is opened and closed without venue staff involvement, which leads to operational efficiencies and ensures that operators are not required to learn a new process.

In one example, the system uses a client/server API architecture, together with an adapter architecture utilising a proxy server that provides secure communication between the venue, and in particular the PoS terminal and account servers. The adapter architecture provides the following benefits over a standard client/server architecture:
Permanent connection between the venue and the account servers. This allows tab to be opened and updated in real-time.
Message buffers. The use of buffering (message queues) within the adapter allow tabs to continue to operate even if a connection is temporarily lost. Updates are queued and then sent as soon as the connection is restored.
The adapter exposes a local API endpoint for the PoS to communicate with. This removes the need for the PoS to communicate outside of the local venue network.

The system can use a proprietary message format to send messages to the PoS. It will also be appreciated that the use of a proxy server allows any messaging format to be used between the account server and terminal, with messages being converted into a format required by the sales terminal as needed.

In use, new customers register to use the arrangement by downloading a native smartphone application, or accessing the service via an embedded HTML5 application within a smartphone application or web site.

Users provide personal details and add a photo so that they can be identified when making purchases in a venue. Optionally, users are able to link to an existing third party social media account such as Facebook, Twitter, or Google+ to automatically complete the registration process. Users add one or more payment types to their account. Payment types include credit and debit cards, and third-party payment providers such as PayPal. Credit cards are added by manually entering the card details, optical character recognition using a smartphone camera (note: OCR technology provided by PayPal), or via integration with a 3^{rd} party digital wallet solution.

Users can open a tab at a pub, restaurant, or hotel using a native App, or an App provided by a client device managed by the venue. User having a compatible smartphone will be automatically prompted to open a tab when they enter a venue equipped with a proximity beacon, with the App utilises Bluetooth low energy (BLE) technology to recognise that the user has entered a participating venue. The App can also present a list of nearby venues and also provides a map view showing all participating venues. GPS technology can be used to identify the customer's location and determine nearby venues.

A tab is opened by selecting a venue, payment type and tab limit. A pre-authorisation transaction can be processed against the selected payment source to guarantee that funds will be available to complete payment when closing the tab. The account server communicates with the PoS terminal in-venue to open a tab and return a venue specific tab number to the customer. The venue receives the customer's name and photo to aid identification when interacting with the user. The provision of a name and photo also allows a tab to be used if a user is unable to show their smartphone to the bar operators, and allows venue staff to greet a user by name.

The user orders items from the bar, server, or venue staff and identifies themselves as a participating user with an open tab. The user will show a “tab card” screen displayed by the App, which includes the tab identifier. Venue staff can provide this to the PoS terminal and further identify the user using the photo sent to the PoS terminal as part of the tab opening process.

Venue staff enter items into the PoS as usual and assign the items to the tab in the same way as using existing manual tabs. Details of the updated tab are sent to the account server and on to the App, so that the user is notified about the update using push message technologies. The user is able to view their tab balance and all items added to the tab in real-time.

Users are able to increase the spending limit for an open tab at any time. The user selects a new tab limit and a pre-authorisation transaction is processed against the selected payment source to guarantee that funds will be available to complete payment when closing the tab. The account server communicates with the PoS in-venue to increase the limit applied to the open tab. In addition to manual increases to the tab limit, the account server can also prompt the user to accept an automatic increase according to business rules derived from the spend pattern on the tab.

The arrangement allows a group of users to share a single tab. The user that originally opened the tab is the tab “owner” and controls which other users can join the tab. The functionality is commonly used for functions where one user will be paying for all purchases.

The tab owner accesses a unique code which is used by other users to join the tab. The user joining the tab enters the share code and, following verification, the owner receives a notification displaying the name and photo of the new sharer and requiring them to accept the share. The tab owner is also able to share a tab by ‘broadcasting’ the tab for a short period of time. While the tab is in this discoverable mode, nearby users are able to request to join the tab, and the owner receives a notification displaying the name and photo of the new sharer and requiring them to accept the share. In this regard, Bluetooth Low Energy (BLE) technology can be used to identify tab owners within a defined proximity. Alternatively, the discoverable tab would be visible to anyone using the ‘join tab’ functionality during the broadcast window.

The owner is able to view a list of all other users sharing the tab and can remove users at any time. They also control whether tab sharers are able to view the balance of the tab, and details of the items added. All parties to a shared tab are able to make payments by selecting a payment method and amount. The arrangement processes the payment and communicates with the PoS in-venue to reduce the outstanding tab balance.

A tab can be closed using one of the following methods:
The user closes the tab from within the app. During the close process they are able to select a tip amount to be added to the bill. A default tip value may be configured for all tabs in a venue.
A member of venue operators closes the tab from within the PoS. This action is commonly taken to close any tabs left open at the end of trading for the day.
A tab may be automatically closed according to business rules such as:
   A period of inactivity
   Venue business hours
   User's physical proximity to the venue. Proximity may be determined by GPS location (geofencing), or moving outside the range of a BLE beacon.

After receiving a close request, the account server processes the payment and communicates with the PoS in-venue to apply payment and close the tab. A receipt is sent to the user by email and details of the transaction are available within the app. The fact that a user is able to leave the venue without needing to settle the tab with venue operators is a major convenience for the user, and an operational efficiency for the venue.

The process can also be used in a restaurant. In this case, the tab need not be opened in advance as a pre-authorised tab, but instead is opened at the time of bill settlement.

In this example, the arrangement enables users in a restaurant to establish and settle the tab at the end of a meal. Before being able to pay, the user must connect themselves with the restaurant bill using one of the following methods:
The user can enter a unique code or number assigned to the restaurant table before being presented with the bill. Once connected, they are able to view the bill in real-time and will be updated on any changes.
When presented with the printed bill by the wait operators, the user can scan a QR code printed on the base of the receipt.
The user may elect to Pay by Check-in (defined below). This options send the user details to the PoS and a member of venue operators then links the user to the open bill.

Once connected to the tab, users are able to view the full details of the bill, add a tip, and select a payment method before confirming payment. The arrangement also provides functionality for two or more diners to split a bill. Each user pays by connecting to the bill and then selecting either a fixed amount to amount, or will select individual items to generate a total to pay. It is also possible for part of the bill to be paid by using the above described techniques, and the remainder by cash or any other payment method accepted by the venue.

To facilitate a single payment, a user can check-in to a participating venue and their details including name and photo are sent to the PoS. To complete the transaction the venue staff member selects an appropriate payment type, such as pay by tab, and then selects the user from the list presented. The user is then prompted to accept the charge and, if accepted, the charge is processed by the account server and confirmation is sent to the PoS in-venue.

Each participating venue can be given access to an admin console to provide real-time access to information on users and tabs. The admin console provides access to real-time transaction data including open tabs and all historic tabs. Detailed payment and reconciliation reports provide clarity on all payments processed using the system.

The venue is also provided with a Business Intelligence (BI) console to enable them to identify trends and users to aid in marketing efforts and management decisions. Item level spend data is aggregated and can be view across multiple dimensions.

The system can also implement further features in the form of marketing tools, including but not limited to:
Push offers in the form of targeted, time sensitive, promotions sent directly to a single user or a group of users.
Corporate discounts such as automatic discounts or rebates applied to the tab spend for employees of a selected company.
Individual discounts such as automatic discounts applied to the tab spend for a selected user (e.g. senior management discount).
Gift cards allowing for a venue to sell virtual gift cards to their users via a web site widget or marketing campaign. The gift card represents pre-purchased tab credit that can be applied to any purchase.

The account server can also be adapted to provide a number of other ancillary services, including for example monitoring and administering loyalty programs, gifting or the like. Additionally, the payment mechanisms can be used in a wide variety of circumstances, including making payments to any third parties on request.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

We claim:

1. Apparatus for managing a tab relating to purchases, the apparatus including:
a) a sales terminal;
b) a client device; and,
c) an account server in communication with the sales terminal and the client device via one or more communications networks, wherein in use:
i) the account server provides an open tab message to the sales terminal;
ii) the sales terminal:
(1) opens a tab for the user; and,
(2) provides a tab identifier message to the account server, the tab identifier message being indicative of a tab identifier;
iii) the account server provides an indication of the tab identifier to the client device allowing a user of the client device to present the tab identifier when making a purchase so that the purchase can be added to the tab;
iv) the sales terminal provides a tab balance message to the account server, the tab balance message being indicative of at least a tab balance; and,
v) the account server:
(1) processes payment of the tab on behalf of the user in accordance with the tab balance; and,
(2) provides payment confirmation to the sales terminal.

2. Apparatus according to claim 1, wherein the apparatus includes a proxy server that communicates with the account server and a sales module in the sales terminal to transfer messages there between.

3. Apparatus according to claim 2, wherein the proxy server is implemented using computer executable code executed by the sales terminal.

4. Apparatus according to claim 2, wherein the proxy server selectively queues messages being transferred between the sales module and the account server.

5. Apparatus according to claim 4, wherein the proxy server:
a) determines if a message should be queued; and,
b) depending on the result of the determination, at least one of:
i) queuing the message; and,
ii) transferring the message.

6. Apparatus according to claim 5, wherein the proxy server determines a message should not be queued in accordance with at least one of:
a) a message type;
b) a message content; and,
c) if the message is a response message.

7. Apparatus according to claim 2, wherein the proxy server:
a) receives a message from the account server via a communications network;
b) queues the message; and,
c) provides the message to the sales module in response to a polling request.

8. Apparatus according to claim 7, wherein the proxy server confirms at least one of:
a) receipt of the message from the account server; and,
b) failure of message delivery to the sales module.

9. Apparatus according to claim 7, wherein the proxy server deletes uncollected queued messages.

10. Apparatus according to claim 2, wherein the proxy server:
a) receives a message from the sales module;
b) queues the message; and,
c) periodically provides queued messages to the account server via a communications network.

11. Apparatus according to claim 2, wherein the proxy server:
a) transfers an open tab message from the account server to the sales module; and,
b) transfers a tab identifier message from the sales module to the account server.

12. Apparatus according to claim 2, wherein the proxy server at least one of:
a) transfers a close tab message from the account server to the sales module;
b) transfers a tab balance message from the sales module to the account server; and,
c) transfers a payment confirmation message from the account server to the sales module.

13. Apparatus according to claim 1, wherein:
a) the client device provides an open tab indication to the account server including an indication of a venue; and,
b) the account server uses the open tab indication to generate the open tab message.

14. Apparatus according to claim 13, wherein the client device:
a) determines a location;
b) displays a list of venues in accordance with the determined location;
c) determines user selection of a venue in accordance with user input commands; and,
d) generates the open tab indication using the selection of a venue.

15. Apparatus according to claim 13, wherein the client device:
a) detects a venue network device or beacon; and,
b) generates the open tab indication at least partially in accordance with detection of the venue network device.

16. Apparatus according to claim 12, wherein:
a) the client device:
i) determines user selection of a tab limit; and,
ii) provides an indication of the tab limit to the account server; and,
b) the account server uses the tab limit indication to generate the open tab message.

17. Apparatus according to claim 16, wherein the account server:
a) performs a pre-authorization transaction based on the tab limit; and,
b) generates the open tab message in response to a successful completion of the pre-authorization transaction.

18. Apparatus according to claim 16, wherein the sales terminal:
a) compares a current tab balance to the tab limit; and,
b) in accordance with the results of the comparison, at least one of:
i) selectively approves a purchase; and,
ii) generates a notification an increased tab limit or payment is required, the notification being displayed on at least one of the sales terminal and the client device.

19. Apparatus according to claim 18, wherein, in response to a purchase:
a) the sales terminal:
i) generates a tab balance message including an updated tab balance; and,
ii) provides the tab balance message to the account server;
b) the account server provides an indication of the tab update to the client device; and,
c) the client device displays an indication of the updated tab balance.

20. Apparatus according to claim 1, wherein:
a) the client device:
i) determines payment information using user input commands; and,
ii) provides an indication of the payment information to the account server; and,
b) the account server processes payment of the tab using the payment information.

21. Apparatus according to claim 1, wherein:
a) the sales terminal closes the tab and provides a tab closed message to the account server, the tab closed message including a final tab balance; and,
b) the account server:
i) processes payment of the tab in accordance with the final tab balance; and,
ii) provides a payment confirmation message to the sales terminal.

22. Apparatus according to claim 21, wherein:
a) the client device provides a close tab indication to the account server in response to user input commands;
b) the account server
i) generates a close tab message; and,
ii) provides the close tab message to the sales terminal; and,
c) the sales terminal closes the tab in response to the close tab message.

23. A method for managing a tab relating to purchases, the method including the steps of:
i) in an account server, providing an open tab message to a sales terminal;
ii) in the sales terminal:
(1) opening a tab for the user; and,
(2) providing a tab identifier message to the account server, the tab identifier message being indicative of the tab identifier;
iii) in the account server, providing the tab identifier to a client device allowing a user of the client device to present the tab identifier when making a purchase so that the purchase can be added to the tab;
iv) in the sales terminal, providing a tab balance message to the account server, the tab balance message being indicative of at least a tab balance; and,
v) in the account server:
(1) processing payment of the tab on behalf of the user in accordance with the tab balance; and,
(2) providing payment confirmation to the sales terminal.

24. Apparatus for messaging in a system for managing a tab, the apparatus including:
a) a sales terminal having a sales module;
b) an account server; and,
c) a proxy server in communication with the sales module and the account server, wherein in use, messages transferred between the account server and sales module are transferred via the proxy server with the proxy server selectively queuing messages as required.

25. Apparatus according to claim 24, wherein the proxy server:
a) determines if a message should be queued; and,
b) depending on the result of the determination, at least one of:
i) queuing the message; and,
ii) transferring the message.

26. Apparatus according to claim 25, wherein the proxy server determines a message should not be queued in accordance with at least one of:
a) a message type;
b) a message content; and,
c) if the message is a response message.

27. Apparatus according to claim 24, wherein the proxy server:
a) receives a message from the account server via a communications network;
b) confirms receipt of the message from the account server;
c) queues the message; and,
d) provides the message to the sales module in response to a polling request from the sales module.

28. Apparatus according to claim 27, wherein the proxy server:
a) confirms failure of message delivery to the sales module; and,
b) deletes uncollected queued messages.

29. Apparatus according to claim 24, wherein the proxy server is implemented using computer executable code executed by the sales terminal.

30. Apparatus according to claim 24, wherein the proxy server:
a) receives a message from the sales module;
b) queues the message; and,
c) periodically provides queued messages to the account server via a communications network.

31. Apparatus according to claim 24, wherein the proxy server, at least one of:
a) transfers a close tab message from the account server to the sales module;
b) transfers an open tab message from the account server to the sales module; and,
c) transfers a tab identifier message from the sales module to the account server.

32. Apparatus according to claim 24, wherein the proxy server:
a) transfers a tab balance message from the sales module to the account server; and,
b) transfers a payment confirmation message from the account server to the sales module.

33. A method for messaging in a system for managing a tab, the system including a proxy server in communication with a sales terminal having a sales module and an account server, the method including the steps of transferring messages between the server and sales module via the proxy server with the proxy server selectively queuing messages as required.
